(19) United States
(12) Patent Application Publication
(10) Pub. No.: US 2015/0278972 A1
(43) Pub. Date: Oct. 1, 2015

(54) METHOD FOR A WEB-BASED, MULTI-COMPONENT SYSTEM FOR RETRIEVING AND EXTRAPOLATING DATA FROM LAWYER PERFORMANCE RECORDS FOR THE PURPOSE OF ASSISTING CLIENTS WITH SELECTION

(71) Applicant: Noetic Insight, Inc., Bunnell, FL (US)

(72) Inventors: Darren McGuire, Orlando, FL (US); Trevor Tucker, Bunnell, FL (US)

(73) Assignee: Noetic Insight, Inc., Bunnell, FL (US)

(21) Appl. No.: 14/225,511

(22) Filed: Mar. 26, 2014

(51) Int. Cl. G06Q 50/18; G06Q 30/06; G06F 17/30

(52) U.S. Cl. CPC G06Q 50/18; G06F 17/30424; G06F 17/30554; G06F 17/30339; G06Q 30/0627

(57) ABSTRACT

A new and useful web-based, multi-component system for retrieving and extrapolating data from lawyer performance records for the purpose of assisting clients with selection which returns query results that are based on quantified attorney case experience and empirical data, is a single resource and location where users can view results for all attorneys, allows the user to sort attorneys based on quantified data and criterion such as years of experience, number of convictions, pleas, and other rates, and tracks attorney experience, trends and changes over time. Typical users that would benefit from access to the present invention would be anyone in the general public who is in need of information that can assist in making a decision concerning legal representation.

### REFERENCE TO SEQUENCE LISTING, A TABLE, OR A COMPUTER PROGRAM LISTING COMPACT DISK APPENDIX

Not Applicable.

### TECHNICAL FIELD

This invention relates generally to databases. More specifically, this invention relates to a method for a web-based, multi-component system for retrieving and extrapolating data from lawyer performance records for the purpose of assisting potential clients with selection.

### BACKGROUND OF THE INVENTION

Lawyer databases are currently used as a means for attorneys and prospective clients to search for legal practitioners. These databases most commonly serve purpose similar to older directories such as phone books, where lawyers are listed by name, practice area and geographic location. Over time lawyer databases have begun to offer other features such as collecting and displaying subjective reviews, complaints and advertisements of the included practitioners.

In the applicant's experience there is a lack of useful lawyer database systems whereby potential clients can make statistically informed and objective decisions on which attorney to hire for a particular case. Few if any such database systems utilize numerically quantified criteria and objective statistical analysis to extrapolate trends and data for each attorney. Most current lawyer search websites provide subjective data only such as peer, customer reviews and opinion, or a general satisfaction indicator—grade, star ranking or the like. Therefore the results are often skewed, flawed or create an exaggerated subjective impression of the attorney of interest. In many cases, the attorneys that are most lauded or visible to the user are those who have paid for advertisements or increased presence on the site. This too creates an air of efficacy and endorsement that is not correlated to the actual attorney performance data—only her ability to purchase ad space.

In the applicant's experience, there is a need for a method for a web-based, multi-component system for retrieving and extrapolating data from lawyer performance records for the purpose of assisting clients with selection which i) returns query results that are based on quantified attorney case experience and empirical data, ii) is a single resource and location where users can view results for all attorneys, iii) allows the user to sort attorneys based on quantified data and criterion such as years of experience, number of convictions, pleas, and other rates, and iv) tracks attorney experience, trends and changes over time. The device of the present invention is believed to accomplish all of the foregoing objectives.

### SUMMARY OF THE INVENTION

The present invention provides a new and useful method, once known by the trade name “Your Gavel,” that allows users to search and view aggregated lawyer information by a variety of quantified variables and parameters, including number of cases tried, pled and “wins.” In the present invention “wins” are defined as any other verdict than “guilty.” The present invention sorts lawyers and other metrics based on quantifiable performance results including numerical values.

The present invention offers an advantage over the current art by utilizing, analyzing and manipulating objective empirical and factual data—including but not limited to case results and experience—to quantify and sort lawyer performance. Data that is traditionally recorded in non-numerical terms are transformed by the present invention into quantifiable data for the purposes of analysis and use. The current invention helps users to decide on which practitioner suits their intended needs by quantifying and comparing attorney case experience, performance and other numerically comparable quantities such as i) case count by type, time and location, ii) case disposition including convictions, charge, duration and location, iii) case dispositions other than convictions, and iv) numbers, rates and types of pleas entered by clients.

This is achieved by way of database operations that are informed by the user-provided input on a web-based user interface query page. The input or parameters provided by the user, also known as a search query, is then run through analysis, operations, searches and filters by the internal database of the present invention—specifically a series of SQL data queries—to yield a result that matches the user search specification and is responsive to the user's specific inquiry. The results of the search are then shown to the user on a web-based user interface query results page, wherefrom the user can make decisions about which attorney to hire.

The present invention achieves this advantage by first compiling a database from available comma separated value files, also known as CSV files. These files are often available from the clerk of the court in a given jurisdiction. The CSV file, which may be pipe-delimited, is transformed by the current invention into a useful database by the implementation of a plurality of intermediate data preparation steps and the integration of created flat files.

In one embodiment of the present invention, a results table for a user interface search is created by the database by implementing a variety of internal query steps including plea check, plea count and performance rates. The results table is thereafter compared electronically to user selections made form a user interface query page to display matching results on a query results page.

In an alternate embodiment of the present invention a results table is created from the database by implementing a series of intermediary steps including plea check and performance queries. In this embodiment, the user selects an attorney by name on a user interface query page. The input data therefrom is compared electronically to the aforementioned results table and displays matching results on a web page.

In at least one embodiment, the invention provides the services free of charge to the public.

Thus the present invention is believed to provide a new and useful method for a web-based, multi-component system for retrieving and extrapolating data from lawyer performance records for the purpose of assisting clients with selection which returns query results that are based on quantified attorney case experience and empirical data, is a single resource and location where users can view results for all attorneys, allows the user to sort attorneys based on quantified data and criterion such as years of experience, number of convictions, pleas, and other rates, and tracks attorney experience, trends and changes over time. Typical users that would benefit from access to the present invention would be anyone in the general public who is in need of information that can assist in making a decision concerning legal representation.

Further features and objectives of the present invention will become apparent form the following detailed description and the accompanying drawings.

### BRIEF DESCRIPTION OF THE DRAWINGS

FIG. 1 is a general flow diagram view of the phases comprising a method for a web-based, multi-component system for retrieving and extrapolating data from lawyer performance records for the purpose of assisting potential clients with selection according to the present invention;

FIG. 2 is a general flow diagram view of the database creation phase of the present invention;

FIG. 3 is a detail flow diagram view of the table creation phase of the present invention;

FIG. 4 is a general flow diagram view of the user query phase of the present invention;

FIG. 5 is a detail flow diagram view of the database operation phase of the present invention;

FIG. 6 is a general flow diagram view of the database query results return phase of the present invention;

FIG. 7 is a wireframe of an example of a web-based user interface query page according to the present invention; and

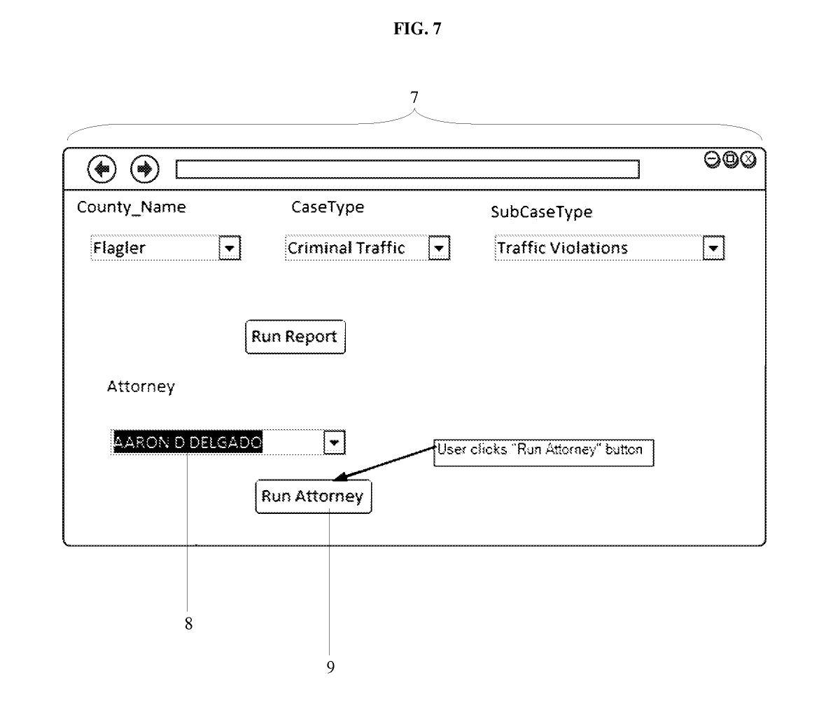

FIG. 8 is a wireframe of an example of a web-based user interface query results page according to the present invention.

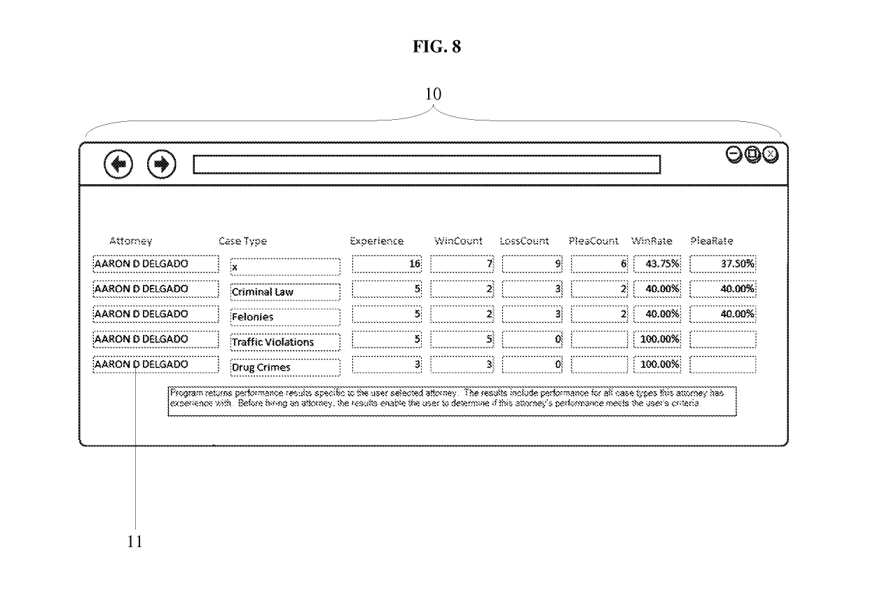

### DETAILED DESCRIPTION OF THE INVENTION

As described above, the present invention provides a new and useful method for a web-based, multi-component system for retrieving and extrapolating data from lawyer performance records for the purpose of assisting clients with selection which returns query results that are based on quantified attorney case experience and empirical data, is a single resource and location where users can view results for all attorneys, allows the user to sort attorneys based on quantified data and criterion such as years of experience, number of convictions, pleas, and other rates, and tracks attorney experience, trends and changes over time. Typical users that would benefit from access to the present invention would be anyone in the general public who is in need of information that can assist in making a decision concerning legal representation. The following description and accompanying drawings disclose at least one version of such a device.

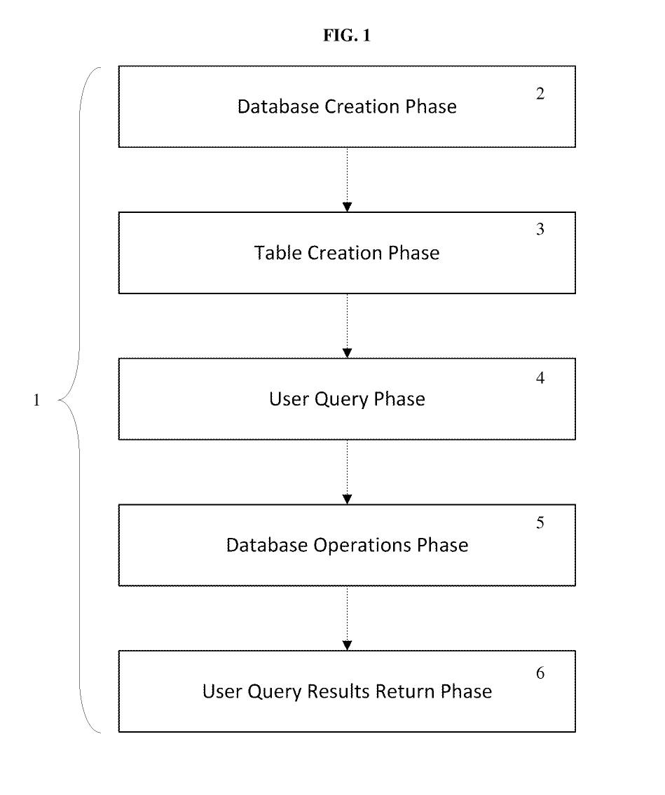

Referring now to the invention in FIG. 1 there is shown a method for a web-based, multi-component system for retrieving and extrapolating data from lawyer performance records for the purpose of assisting clients with selection shown generally 1 comprising a database creation phase 2, a table creation phase 3 following the database creation phase 2, a user query phase 4 following the table creation phase 3, a database operations phase 5 following the user query phase 4, and a database query results return phase 6 following the database operation phase 5.

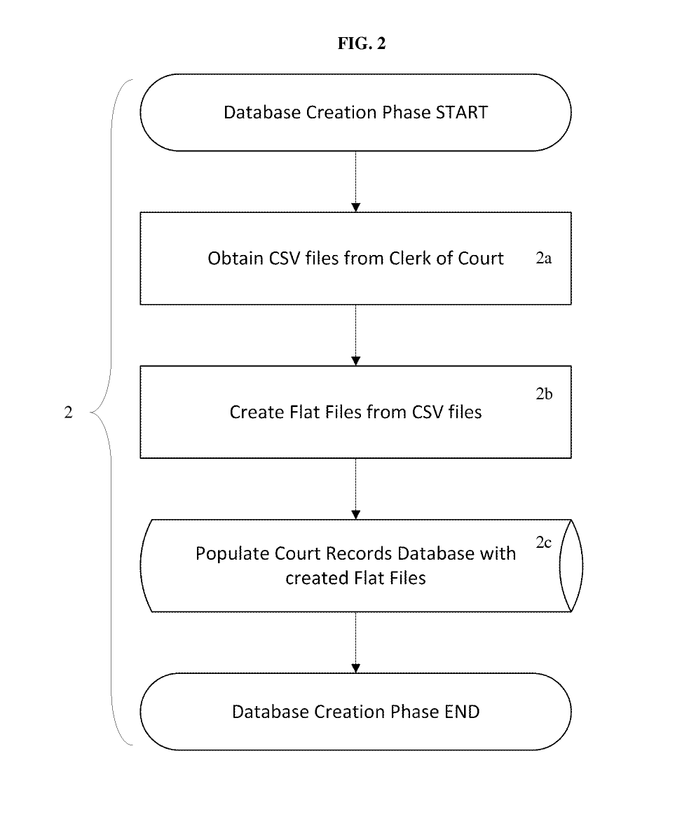

Referring now to the invention in FIG. 2, the database creation phase 2 is accomplished utilizing the steps comprising first obtaining a plurality of available comma separated value files from the clerk of the court office 2a in a particular jurisdiction. The said comma separated value files include record data and information relating to court cases. The said comma separated value files may also be pipe-delimited.

Next, flat files are created by transforming the comma separated value files 2b into a useful database for the purpose of this invention. Transforming is accomplished by implementing a plurality of intermediate data preparation steps and integration of other created flat files. The resultant useful database thereby includes a plurality of database tables having columns and rows of data.

The final step for the database creation phase 2 is populating a court records database of the present invention with the flat files 2c.

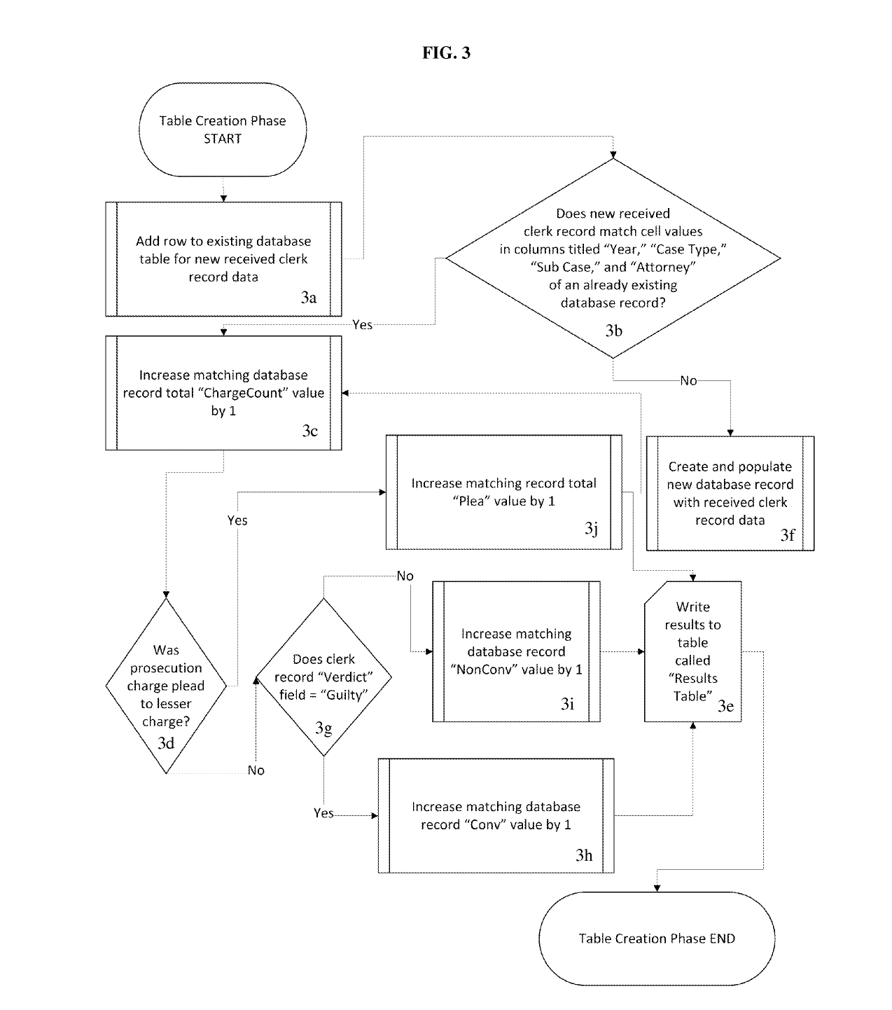

Referring now to FIG. 3, the table creation phase 3 is accomplished by the database utilizing the steps comprising first adding a row to an existing database table in the useful database to receive clerk record data 3a. The database then performs a matching determination step 3b. The said matching determination step 3b is performed by the database of the present invention to determine if the newly received clerk record has matching cell values in columns of an already existing matching database record. The said columns include titles such as year, case type, sub case, and attorney. If no match is made with an existing database record, a new database record is optionally created and populated with the received clerk data 3f.

Next, the database increases the matching database record total charge count by 1 3c. The table creation phase 3 continues by performing a prosecution determination step 3d. The prosecution determination step 3d is performed by the database of the present invention to determine if the charge of database record was pled to a lesser charge. If the prosecution determination step yields an affirmative response, the database increases the matching database record total plea value by 1 3j. Finally, the database completes the table creation phase 3 by writing results of the table creation phase 3 to a results table.

In the event that the prosecution determination step 3d yields a negative response, the database performs the steps of optionally performing a verdict determination step 3g. In the verdict determination step 3g the database of the present invention to determines if the clerk record verdict field is equal to guilty. If the verdict determination step 3g yields an affirmative response, the database increases the matching database record conv value by 1 3h. For the purposes of this embodiment the conv value reflects convictions. The results of the table creation phase are written to a results table 3e.

Conversely, if the verdict determination step 3g yields a negative response, the database increases the matching database record nonconv value by 1 3i. For the purposes of this embodiment the nonconv value reflects non-conviction case disposition. The results of the table creation phase are then written to a results table 3e.

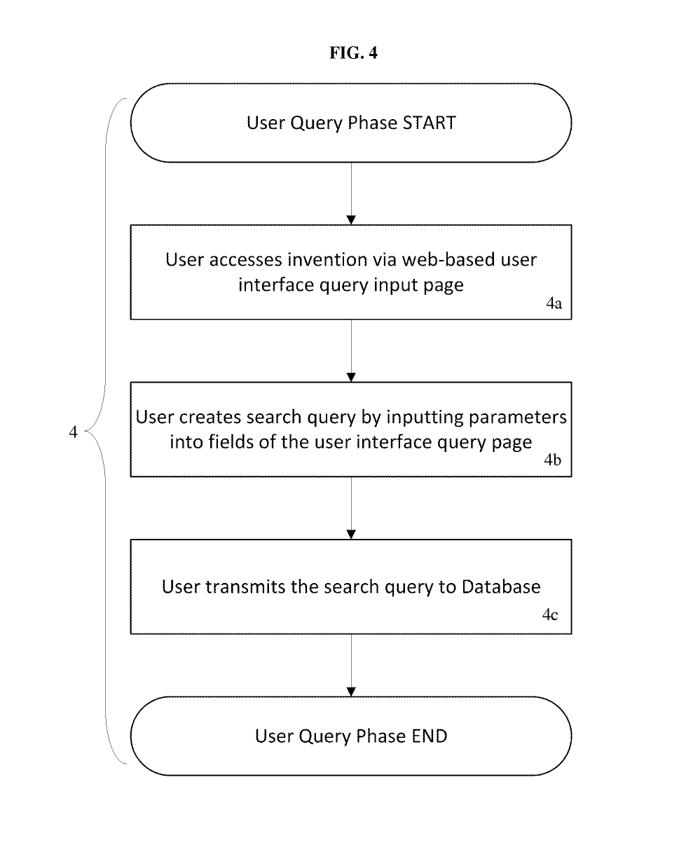

Referring now to the invention in FIG. 4, the user query phase 4 is accomplished by the user performing the steps comprising first accessing of the invention 4a by visiting a web-based user interface query input page 7. While on the page, the user creates a search query by inputting user-provided parameters into the input fields 8 of the interface query input page 7. Said input fields 8 receive said user-provided parameters including data relating to a desired search criteria of the user and specifically relating to lawyer performance and case data.

Finally, the user transmits the search query to the database 4c of the present invention. This step can be performed by selecting a run or transmit button 9.

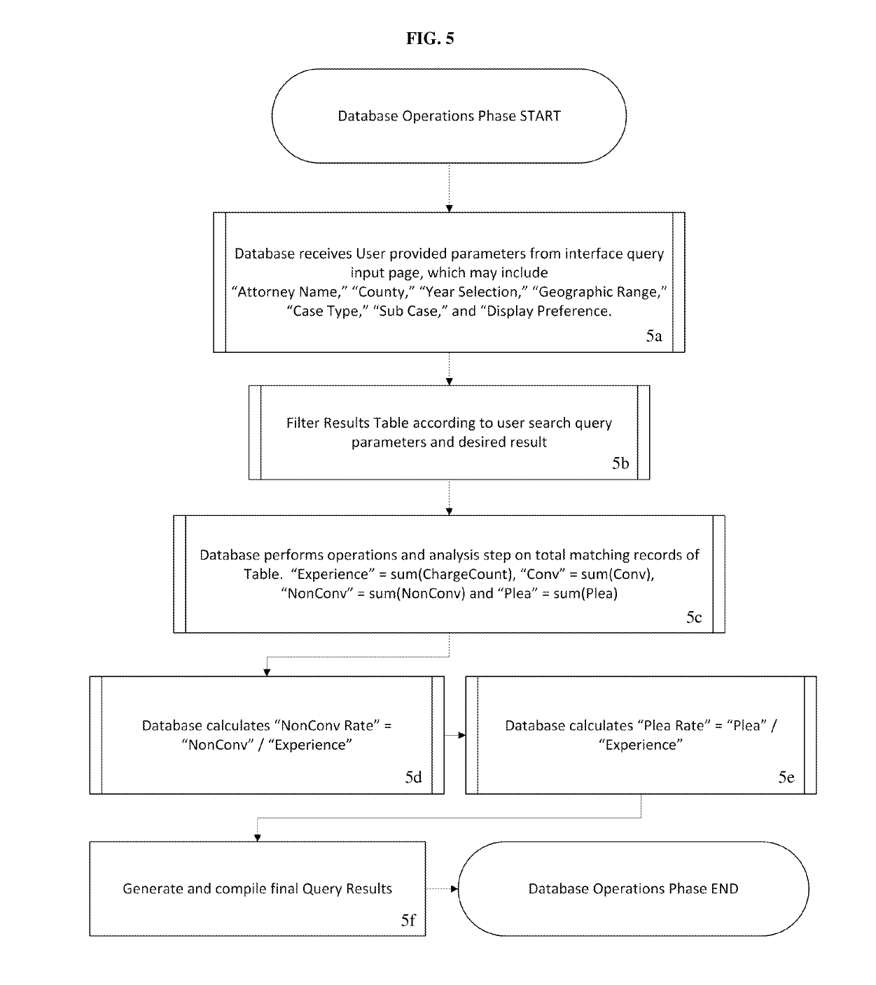

Referring now to the invention in FIG. 5, the database operations phase 5 is accomplished by the database utilizing steps comprising first receiving user provided parameters 5a from the user interface query page 7. These parameters may include user input fields 8 named and dates relating to attorney name, county, year selection, geographic range, case type, sub case, and display preference. The parameters are elected by the user according to the results desired by her.

Next the database performs an operation wherein the results table is filtered according to the user search query parameters and desired result 5b. This filtering occurs in a series of sequential operations including, filtering and sorting in a hierarchical manner and can occur in any order that narrows results according to the desired result of the user.

Next the database performs operations and analysis steps on total matching records of the results table 5c. These operations include summation of data to calculate aggregate experience, conv, nonconv, and plea values.

The database also calculates a nonconv rate of the total matching results 5d, where nonconv rate equals nonconv value divided by the experience value.

The database then calculates a plea rate of the total matching results 5e, where plea rate equals plea value divided by experience value.

Finally the database operation phase 5 ends after the final query results are generated and compiled.

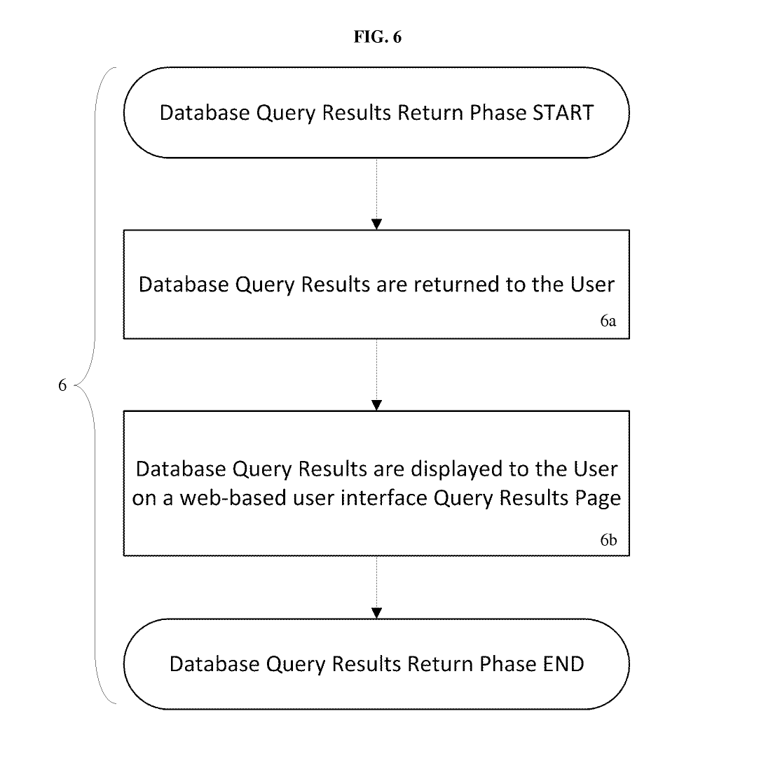

Referring now to the invention in FIG. 6, the database query results return phase 6 is accomplished by the database utilizing the steps comprising first returning a plurality of database query results to the user 6a and displaying the database query results to the user 6b on a web-based user interface query results page 10. Database query results 11, which in at least one embodiment includes calculated rates, are displayed in fields on the web-based user interface query results page 10.

In at least one embodiment of the present invention, the comma separated value files are pipe-delimited files.

In an alternate embodiment of the present invention, the table creation phase 3 optionally follows the user query phase 4.

The previously described versions of the present invention have many advantages, including and without limitation, the properties of being a method that i) returns query results that are based on quantified attorney case experience and empirical data, ii) is a single resource and location where users can view results for all attorneys, iii) allows the user to sort attorneys based on quantified data and criterion such as years of experience, number of convictions, pleas, and other rates, and iv) tracks attorney experience, trends and changes over time. The device of the present invention is believed to accomplish all of the foregoing objectives. The invention does not require that all the advantageous features and all the advantages need to be incorporated into every embodiment of the invention.

Although the present invention has been described in considerable detail with reference to certain preferred versions thereof, other versions are possible. Therefore the spirit and scope of the appended claims should not be limited to the description of the preferred versions contained therein.

The reader's attention is directed to all papers and documents which are filed concurrently with this specification and which are open to public inspection with this specification, and the contents of all such papers and documents are incorporated herein by reference.

All the features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. As for “means for” elements, the applicant intends to encompass within the language any structure presently existing or developed in the future that performs the same function. The invention should therefore not be limited by the above described embodiment, method, and examples, but by all embodiments and methods within the scope and spirit of the invention.

What is claimed is:

1. A method for web-based, multi-component system for retrieving and extrapolating data from lawyer performance records for the purpose of assisting clients with selection comprising:
a) a database creation phase;
b) a table creation phase following the database creation phase;
c) a user query phase following the table creation phase;
d) a database operations phase following the user query phase; and
e) a database query results return phase following the database operation phase.

2. The method as in claim 1, where the database creation phase is accomplished utilizing the steps comprising:
a) obtaining a plurality of available comma separated value files from the clerk of the court office in a particular jurisdiction,
said comma separated value files including record data and information relating to court cases;
b) creating flat files by transforming the comma separated value files into a useful database for the purpose of this invention,
said transforming is accomplished by implementing a plurality of intermediate data preparation steps and integration of other created flat files,
said useful database including a plurality of database tables having columns and rows of data; and
c) populating a court records database of the present invention with the flat files.

3. The method as in claim 1, where the user query phase is accomplished by the user utilizing the steps comprising:
a) accessing of the invention by visiting a web-based user interface query input page;
b) creating a search query by inputting user-provided parameters into the fields of the interface query input page,
said user-provided parameters including data relating to a desired search criteria of the user and specifically relating to lawyer performance and case data; and
c) transmitting the search query to the database of the present invention.

4. The method as in claim 1 where the database query results return phase is accomplished by the database utilizing the steps comprising:
a) returning a plurality of database query results to the user; and
b) displaying the database query results to the user on a web-based user interface query results page.

5. The method as in claim 1 where the table creation phase is accomplished by the database utilizing the steps comprising:
a) adding a row to an existing database table in the useful database to receive clerk record data;
b) performing a matching determination step,
said matching determination step is performed by the database of the present invention to determine if the newly received clerk record has matching cell values in columns of an already existing matching database record,
said columns having titles including year, case type, sub case, and attorney;
c) optionally creating a new database record if no match is made with an existing database record;
d) increasing the matching database record total charge count by 1;
e) performing a prosecution determination step,
said prosecution determination step is performed by the database of the present invention to determine if the charge of database record was pled to a lesser charge;
f) increasing the matching database record total plea value by 1, if the prosecution determination step yields an affirmative response; and
g) writing results of the table creation phase to a results table.

6. The method of claim 5 further comprising the steps of optionally performing a verdict determination step, if the prosecution determination step yields a negative response, said verdict determination step is performed by the database of the present invention to determine if the clerk record verdict field is equal to guilty.

7. The method of claim 6 further comprising the steps of increasing the matching database record conv value by 1 if the verdict determination step yields an affirmative response, and writing results of the table creation phase to a results table.

8. The method of claim 6 further comprising the steps of increasing the matching database record nonconv value by 1, if the verdict determination step yields a negative response, and writing results of the table creation phase to a results table.

9. The method as in claim 1 where the database operations phase is accomplished by the database utilizing steps comprising:
a) receiving user provided parameters from the user interface query page,
said parameters may include fields named and date relating to attorney name, county, year selection, geographic range, case type, sub case, and display preference,
said parameters are elected by the user according to the results desired by the user;
b) filtering the results table according to the user search query parameters and desired result,
said filtering occurs in a series of sequential operations including, filtering and sorting in a hierarchical manner and can occur in any order that narrows results according to the desired result of the user;
c) performing operations and analysis steps on total matching records of the results table,
said operations include summation of data to calculate aggregate experience, conv, nonconv, and plea values;
d) calculating a nonconv rate of the total matching results, where nonconv rate equals nonconv value divided by the experience value;
e) calculating a plea rate of the total matching results, where plea rate equals plea value divided by experience value; and
f) generating and compiling final query results.

10. The method in claim 2 where the comma separated value files are pipe delimited files.

11. The method as in claim 1 where the table creation phase optionally follows the user query phase.
